(19) United States
(12) Patent Application Publication
(10) Pub. No.: US 2017/0149697 A1
(43) Pub. Date: May 25, 2017

(54) DATA TRANSMISSION SYSTEM AND METHOD OF USING THE SAME

(71) Applicants: INVENTEC (PUDONG) TECHNOLOGY CORPORATION, SHANGHAI (CN); INVENTEC CORPORATION, TAIPEI CITY (TW)

(72) Inventor: Chia-Hsiang CHEN, TAIPEI CITY (TW)

(21) Appl. No.: 15/086,090

(22) Filed: Mar. 31, 2016

(30) Foreign Application Priority Data
Nov. 20, 2015 (CN) 201510809994.6

(51) Int. Cl. H04L 12/939; H04L 12/833; H04L 12/26

(52) U.S. Cl. CPC H04L 49/557; H04L 43/0847; H04L 43/50; H04L 47/31

(57) ABSTRACT

A data transmission system includes a master terminal and a slave terminal. The master terminal is used to output a received data and to input a transmitted data. The slave terminal is used to be electrically connected with the master terminal. The slave terminal includes a receiving region, an interrupt-signal detecting unit, a receiving-data temp region, a transmitting-data temp region, a transmitting region, and a receiving-data integrity determining unit. The interrupt-signal detecting unit is used to determine whether the data transmission system receives an interrupt signal, and to generate either a first result or a second result, accordingly. The receiving-data integrity determining unit is used to determine whether the received data is completely transmitted by judging a flag address of the received data and/or comparing whether the received data is the same as a previous received data, based on the first result.

### BACKGROUND OF THE INVENTION

Field of Invention

The present invention relates to a data transmission system and method of using the same, and in particular to serial information of shifty bus field.

Description of Prior Art

Please refer to FIG. 1, which is a schematic drawing of a data transmission system 10 of a conventional art. The data transmission system 10 is a master-slave architecture of full-duplex data transmission/receiving, which comprises a master terminal 11 and a slave terminal 12. The master terminal 11 transmits clock signals 13 and latch signals 14, to inform the slave terminal 12 when to receive and transmit data, and to synchronize transmitting clock; data are respectively transmitted and received through data output line 15 and data input line 16 disposed between the master terminal 11 and the slave terminal 12. Generally, in a process of serial data transmission of the data transmission system of the conventional art, the master terminal 11 and the slave terminal 12 do not need to control the transmission/receiving of data. Each transmitting/receiving data has a fixed frame length, pointing to an address of a current received/transmitted data from an inner flag, to send the completely received data into an inner logistic controller (such as complex programmable logic device, CPLD), to achieve a function of system control or data record.

However, this transmitting architecture has a drawback: the serial data transmission of the shifty bus between the master terminal 11 and the slave terminal 12 might be incomplete, while the system encounters an interrupt in receiving a high priority suddenly. Because the interrupt happens suddenly, the master terminal 11 is not able to know whether the serial data received by the slave terminal 12 is complete or not, and is not able to know which bit of the whole frame is received by the slave terminal 12; after the interrupt situation is finished, the transmission of the serial data is reactivated to re-transmit the serial data again or to continue transmitting a next serial data.

Hence, it is necessary to provide a data transmission system and a method of using the same to solve the technical issue above.

### SUMMARY OF THE INVENTION

Hence, an objective of the present invention is to provide a data transmission system, to solve the technical issue that after the conventional data transmission system has an interrupt signal, the system is only able to re-transmit the serial data again or to continue transmitting a next serial data.

To achieve the above objective, the present invention provides a data transmission system, which comprises a master terminal and a slave terminal.

The master terminal is used to output a received data and to input a transmitted data.

The slave terminal is electrically connected with the master terminal. The slave terminal further comprises a receiving region, an interrupt-signal detecting unit, a receiving-data temp region, a transmitting-data temp region, a transmitting region, and a receiving-data integrity determining unit.

The receiving region is used to receive and store a latest of the received data. The interrupt-signal detecting unit is used to determine whether the data transmission system receives an interrupt signal, and to generate either a first result or a second result, accordingly. The receiving-data temp region is used to store a previous received data which is completely received. The transmitting-data temp region is used to record a flag address of the received data, a flag address of the transmitted data and the first result. The transmitting region is used to transmit at least one of the transmitted data, a flag address of the received data, a flag address of the transmitted data and the first result, to the master terminal. The receiving-data integrity determining unit is used to determine whether the received data is completely transmitted by judging a flag address of the received data and/or comparing whether the received data is the same as the previous received data, based on the first result.

In one preferred embodiment, the receiving-data integrity determining unit further comprises a flag address determining sub-unit, which is used to determine whether a counting of the flag address of the latest of the received data is complete based on the first result, and to confirm whether the received data is completely transmitted.

In one preferred embodiment, the receiving-data integrity determining unit further comprises a flag address determining sub-unit, which is used to store the latest of the received data to the receiving-data temp region based on the second result and the flag address of the latest of the received data which is completely counted.

In one preferred embodiment, the receiving-data integrity determining unit further comprises a data comparison sub-unit, which is used to compare whether the latest of the received data is the same as the previous received data based on the first result, and thereby to confirm whether the received data is completely transmitted.

In one preferred embodiment, the receiving-data integrity determining unit further comprises a data comparison sub-unit, which is used to compare whether the latest of the received data is the same as the previous received data based on the first result and the counting of the of the flag address of the latest of the received data, and thereby to confirm whether the received data is completely transmitted.

In one preferred embodiment, the received data, the previous received data and the transmitted data are serial information.

To achieve the above objective, the present invention provides a data transmitting method, which comprises: first, step S01, outputting a received data from a master terminal to a slave terminal, and inputting a transmitted data from the slave terminal to the master terminal; then, step S02, determining whether the data transmission system receives an interrupt signal by an interrupt-signal detecting unit, and to generate either a first result or a second result, accordingly; then, step S03, determining whether the received data is completely received by a receiving-data integrity determining unit, if not, then proceeding to step S04; then, step S04, storing a flag address of the received data, a flag address of the transmitted data and the first result to a transmitting-data temp region; then, step S05, determining whether the interrupt signal is finished by the interrupt-signal detecting unit, if yes, then proceeding to step S06; and, lastly, step S06, outputting at least one of the transmitted data, a flag address of the received data, a flag address of the transmitted data and the first result, to the master terminal from a transmitting region of the slave terminal.

In one preferred embodiment, the step S03 further comprises: step S07, determining whether a counting of the flag address of the latest of the received data is complete by a flag address determining sub-unit of the receiving-data integrity determining unit based on the first result, and thereby to confirm whether the received data is completely transmitted, if no, then proceeding step S04.

In one preferred embodiment, the step S03 further comprises: step S08, comparing whether the latest of the received data is the same as the previous received data by a data comparison sub-unit of the receiving-data integrity determining unit based on the first result, and thereby to confirm whether the received data is completely transmitted, if no, then proceeding to step S04.

In one preferred embodiment, the step S03 further comprises: step S07, determining whether a counting of the flag address of the latest of the received data is complete by a flag address determining sub-unit of the receiving-data integrity determining unit based on the first result, and step S08, comparing whether the latest of the received data is the same as the previous received data by a data comparison sub-unit of the receiving-data integrity determining unit based on the first result, and thereby to confirm whether the received data is completely transmitted, if no, then proceeding to step S04.

In one preferred embodiment, the received data, the previous received data, and the transmitted data are serial information.

With comparison with the conventional art, the data transmission system of the present invention solves the technical issue that after the conventional data transmission system has an interrupt signal, the system is only able to re-transmit the serial data again or to continue transmitting a next serial data, by disposing an interrupt-signal detecting unit and a receiving-data integrity determining unit.

To allow the present invention to be more clearly understood, preferred embodiments are given below, and accompanied with drawings, and are described in detail as follows:

### BRIEF DESCRIPTION OF THE DRAWINGS

FIG. 1 is a schematic drawing of a data transmission system of a conventional art;

FIG. 2 is a schematic drawing of a first preferred embodiment of a data transmission system of the present invention;

FIG. 3 is a detailed schematic drawing of a receiving region and a transmitting region of the data transmission system FIG. 2;

FIG. 4 is a schematic drawing of a second preferred embodiment of a data transmission system of the present invention;

FIG. 5 is a schematic drawing of a third preferred embodiment of a data transmission system of the present invention;

FIG. 6 is a schematic drawing of a fourth preferred embodiment of a data transmission system of the present invention;

FIG. 7 is a first flow diagram of the data transfer method of the present invention;

FIG. 8 is a second flow diagram of the data transfer method of the present invention;

FIG. 9 is a third flow diagram of the data transfer method of the present invention; and

FIG. 10 is a fourth flow diagram of the data transfer method of the present invention.

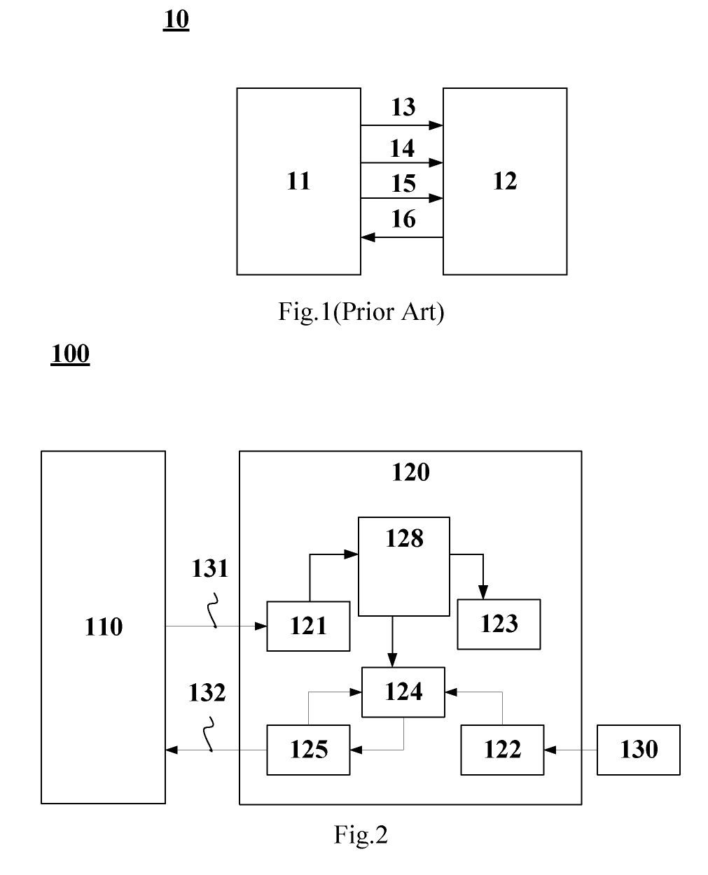

### DETAILED DESCRIPTION OF THE PREFERRED EMBODIMENTS

The following description of each embodiment, with reference to the accompanying drawings, is used to exemplify specific embodiments which may be carried out in the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention.

Please refer to FIG. 2, which is a schematic drawing of a first preferred embodiment of a data transmission system 100 of the present invention. The data transmission system 100 is a shifty bus architecture, which comprises a master terminal 110 and a slave terminal 120.

The master terminal 110 is used to output a received data 131 and to input a transmitted data 132. The slave terminal 120 is used to be electrically connected with the master terminal 110. The slave terminal 120 further comprises a receiving region 121, an interrupt-signal detecting unit 122, a receiving-data temp region 123, a transmitting-data temp region 124, a transmitting region 125, and a receiving-data integrity determining unit 128.

Generally, a transmission of a series of serial data is received by the receiving region 121, and a latest of the received data 131 is stored by the same. Under a situation without any interrupt signal 130, the latest of the received data 131 will be stored at the receiving-data temp region 123. In other words, the latest of the received data 131 will be stored at the receiving-data temp region 123, and become a previous received data when it is completely received. The transmitting region 125 is used to transmit the transmitted data 132.

However, in actual operation, the data transmission system 100 is inevitably going to receive the interrupt signal 130. The interrupt-signal detecting unit 122 of the data transmission system 100 of the preferred embodiment will routinely or casually determine whether the data transmission system 100 is receiving the interrupt signal 130, to generate either a first result or a second result, accordingly. The first result means a determined signal of receiving the interrupt signal 130, the second result means a determined signal of receiving no interrupt signal 130. Meanwhile, the transmitting-data temp region 124 is used to record a flag address of the received data 131, a flag address of the transmitted data 132, and the first result. The transmitting region 124 is used to transmit at least one of the transmitted data 132, and the flag address of the received data 131, the flag address of the transmitted data 132 and the first result, to the master terminal 110. Then, the master terminal 110 is able to know at least one of which bit of the received data 131 is currently transmitted, which bit of the transmitted data 132 is currently received, and whether the data transmission system 100 receives the interrupt signal 130.

Specially, in the data transmission system 100, the receiving-data integrity determining unit 128 is used to determine whether the received data 131 is completely transmitted by judging a flag address of the latest of the received data 131 and/or comparing whether the latest of the received data 131 is the same as a previous received data, based on the first result.

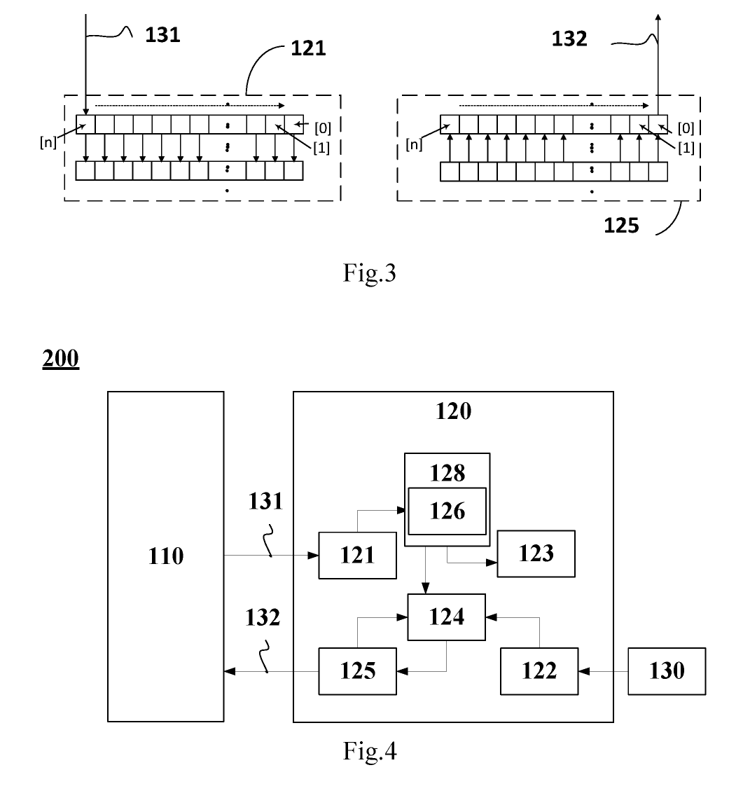

FIG. 3 is a detailed schematic drawing of the receiving region 121 and the transmitting region 125 of the data transmission system 100 of FIG. 2. Preferably, in the transmission of serial data, the received data 131 and the transmitted data 132 are both serial information, which is able to be transmitted by bits as the smallest unit. As shown in FIG. 3, the received data 131 is transmitted from the [n] bit to the receiving region 121 one bit by one bit. When the data transmission system 100 receives the interrupt signal 130, then an information of the transmitted bits (flag address) is stored at the transmitting-data temp region 124. The situation for the transmitted data 132 is the same.

FIG. 4 is a schematic drawing of a second preferred embodiment of a data transmission system 200 of the present invention. The difference between the second preferred embodiment and the first preferred embodiment is that the receiving-data integrity determining unit 128 further comprises a flag address determining sub-unit 126. The flag address determining sub-unit 126 is used to determine whether a counting of the flag address of the latest of the received data 131 is complete based on the first result, and thereby to confirm whether the received data 131 is completely transmitted. Meanwhile, the flag address determining sub-unit 126 is also used to store the latest of the received data 131 to the receiving-data temp region 124 based on the second result and the flag address of the latest of the received data 131 which is completely counted.

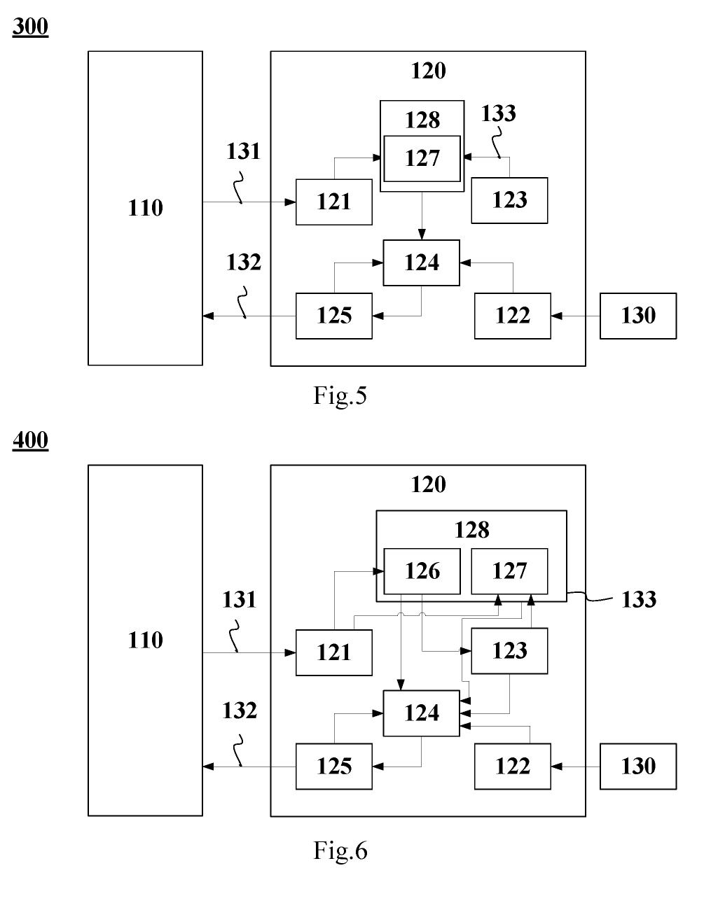

FIG. 5 is a schematic drawing of a third preferred embodiment of a data transmission system 300 of the present invention. The difference between the third preferred embodiment and the first preferred embodiment is that the receiving-data integrity determining unit 128 further comprises a data comparison sub-unit 127, which is used to compare whether the latest of the received data 131 is the same as the previous received data based on the first result, and thereby to confirm whether the received data 131 is completely transmitted. The differences between the data comparison sub-unit 127 and the flag address determining sub-unit 126 are that the data comparison sub-unit 127 is used to compare the data of the whole frame, however, the flag address determining sub-unit 126 is used to count bits of each of the frame. In short, one is used to compare the whole frame, and the other is used to count bits of each single frame.

FIG. 6 is a schematic drawing of a fourth preferred embodiment of a data transmission system 400 of the present invention. The difference between the fourth preferred embodiment and the third preferred embodiment is that the receiving-data integrity determining unit 128 further comprises a flag address determining sub-unit 126. The flag address determining sub-unit 126 is used to determine whether the received data 131 and/or the transmitted data 132 is/are completely transmitted by counting the flag address of the received data 131 and/or the flag address of the transmitted data 132, based on the first result. In the preferred embodiment, the flag address determining sub-unit 126 and the data comparison sub-unit 127 can operate at the same time (or in order), and to determine a transmission status of the data transmission system 400 by the results generated by the two sub units 126, 127.

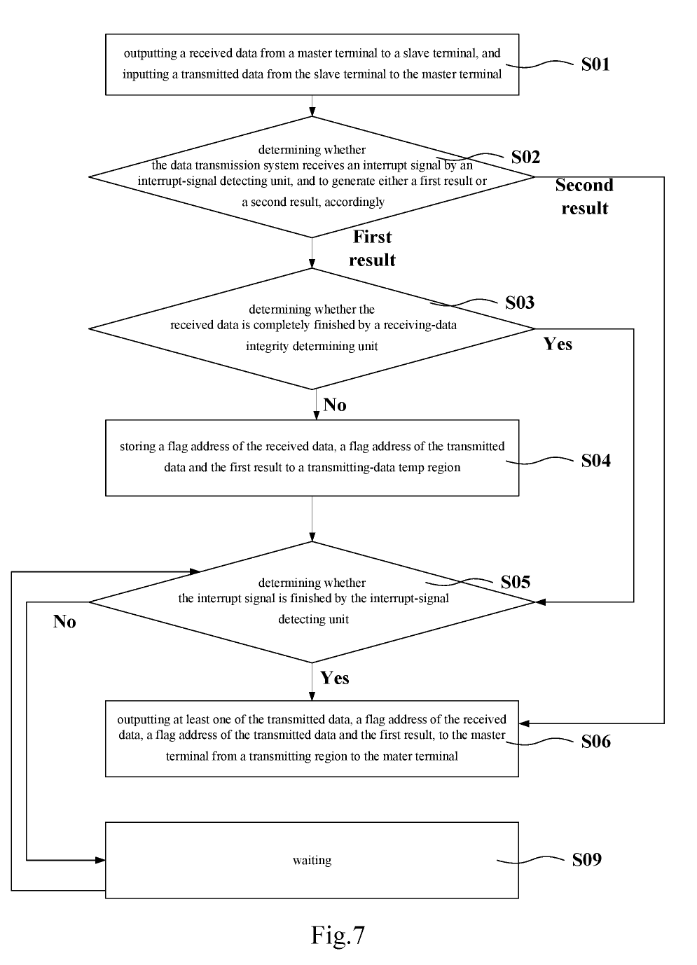

FIG. 7 is a first flow diagram of the data transfer method of the present invention. Please refer to the elements of the first preferred embodiment. First, proceeding to step S01, outputting a received data 131 from a master terminal 110 to a slave terminal 120, and inputting a transmitted data 132 from the slave terminal 120 to the master terminal 110; then, proceeding to step S02, determining whether the data transmission system 100 receives an interrupt signal 130 by an interrupt-signal detecting unit 122, and generating either a first result or a second result, accordingly; then, proceeding to step S03, determining whether the received data 131 is completely received by a receiving-data integrity determining unit 128, if not, then proceeding to step S04; then, proceeding to step S04, storing a flag address of the received data 131, a flag address of the transmitted data 132 and the first result to a transmitting-data temp region 124; then, proceeding to step S05, determining whether the interrupt signal 130 is finished by the interrupt-signal detecting unit 122, if yes, then proceeding to step S06; and, lastly, proceeding the step S06, outputting at least one of the transmitted data 132, a flag address of the received data 131, a flag address of the transmitted data 132, and the first result, to the master terminal 110 from a transmitting region 125 of the slave terminal 120.

In the step S02, if no, then proceeding to step S06. In the step S03, if yes, then proceeding to step S05. In the step S05, if no, then proceeding to step S09, waiting until the interrupt signal 130 is finished. Then, proceeding to step S05 when the interrupt signal 130 is not finished.

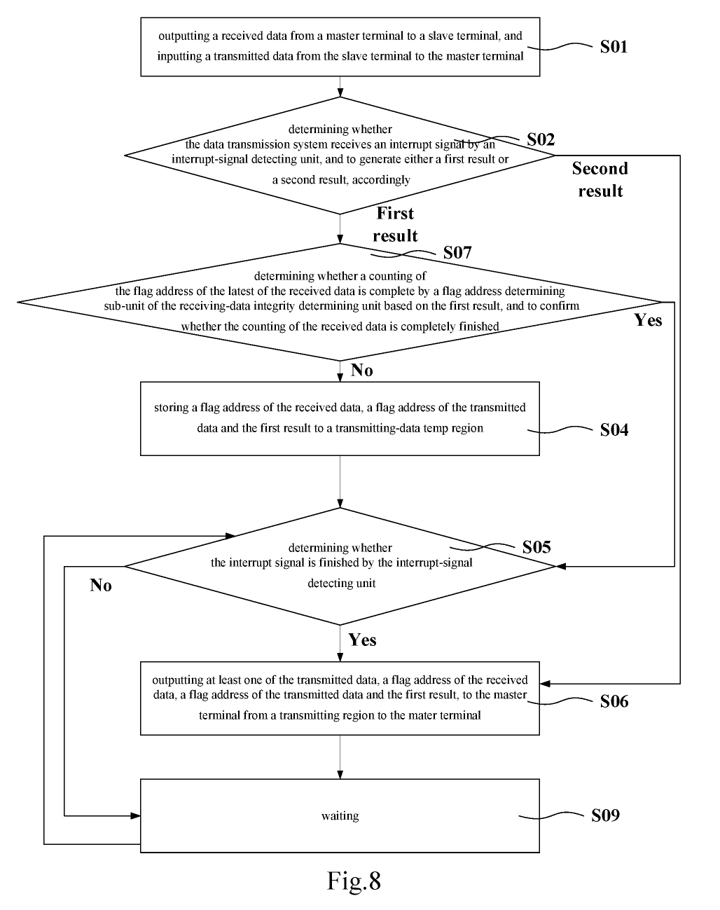

FIG. 8 is a second flow diagram of the data transfer method of the present invention. Please refer to the elements of the second preferred embodiment. The difference between the second flow diagram and the first flow diagram is exchanging the step S03 with the step S07, determining whether a counting of the flag address of the latest of the received data 131 is complete by a flag address determining sub-unit 126 of the receiving-data integrity determining unit 128 based on the first result, and confirming whether the received data 131 is completely received, if no, then proceeding to step S04.

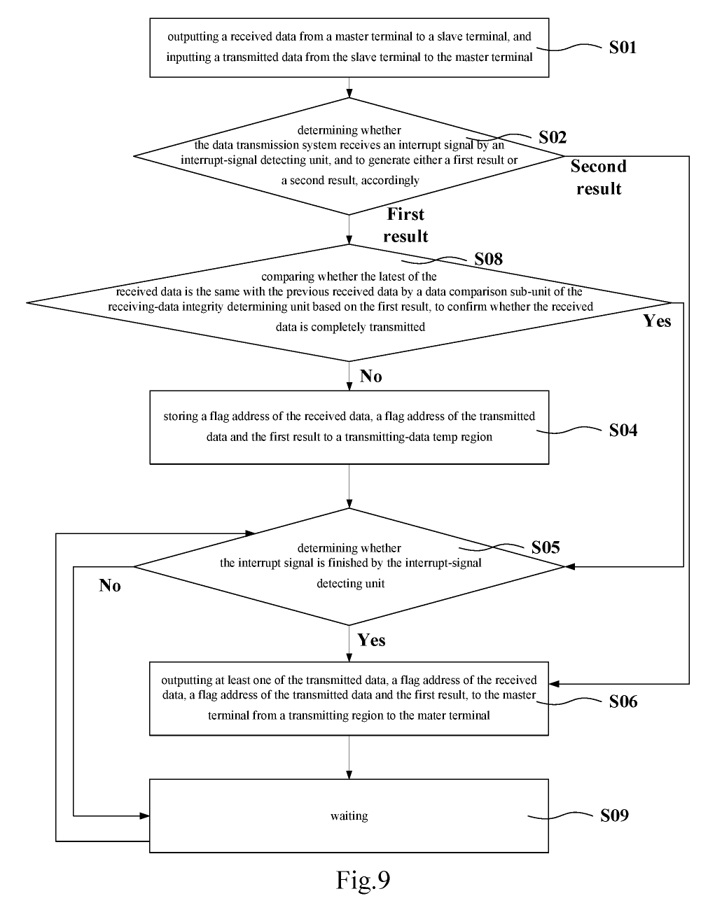

FIG. 9 is a third flow diagram of the data transfer method of the present invention. Please refer to the elements of the third preferred embodiment. The difference between the third flow diagram and the first flow diagram is exchanging the step S03 with the step S08, comparing whether the latest of the received data 131 is the same as the previous received data by a data comparison sub-unit 127 of the receiving-data integrity determining unit 128 based on the first result, and thereby to confirm whether the received data 131 is completely transmitted, if no, then proceeding to the step S04.

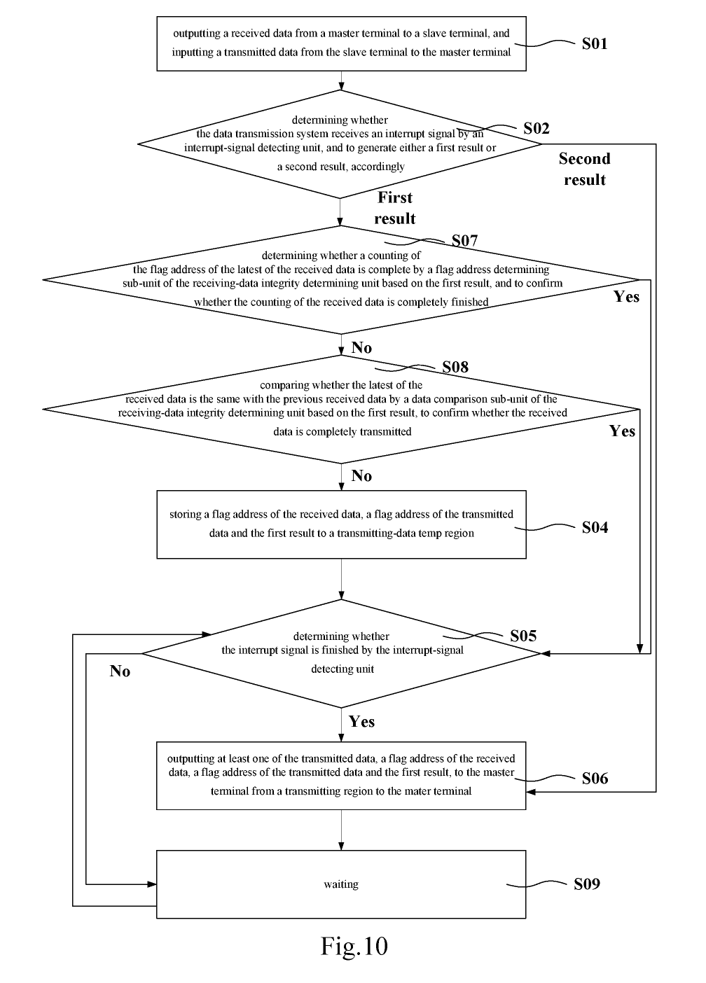

FIG. 10 is a fourth flow diagram of the data transfer method of the present invention. Please refer to the elements of the fourth preferred embodiment. The difference between the fourth flow diagram and the second flow diagram is after proceeding to the step S07, then proceeding to the step S08, comparing whether the latest of the received data 131 is the same with the previous received data by a data comparison sub-unit 127 of the receiving-data integrity determining unit 128 based on the first result, and thereby to confirm whether the received data 131 is completely transmitted, if no, then proceeding to the step S04. The sequence of the step S07 and the step S08 is exchangeable.

Although the present invention has been disclosed as preferred embodiments, the foregoing preferred embodiments are not intended to limit the present invention. Those of ordinary skill in the art, without departing from the spirit and scope of the present invention, can make various kinds of modifications and variations to the present invention. Therefore, the scope of the claims of the present invention must be defined.

What is claimed is:

1. A data transmission system, comprising:
a master terminal, being used to output a received data and to input a transmitted data; and
a slave terminal, being used to be electrically connected with the master terminal, the slave terminal further comprising:
a receiving region, being used to receive and store a latest of the received data;
an interrupt-signal detecting unit, being used to determine whether the data transmission system receives an interrupt signal, and to generate either a first result or a second result, accordingly;
a receiving-data temp region, being used to store a previous received data which being completely received;
a transmitting-data temp region, being used to record a flag address of the received data, a flag address of the transmitted data, and the first result;
a transmitting region, being used to transmit at least one of the transmitted data, a flag address of the received data, a flag address of the transmitted data, and the first result, to the master terminal; and
a receiving-data integrity determining unit, being used to determine whether the received data is completely transmitted by judging a flag address of the received data and/or comparing whether the received data is the same with a previous received data, based on the first result.

2. The data transmission system according to claim 1, wherein the receiving-data integrity determining unit further comprises a flag address determining sub-unit, being used to determine whether a counting of the flag address of the latest of the received data is complete based on the first result, and to confirm whether the received data is completely transmitted.

3. The data transmission system according to claim 1, wherein the receiving-data integrity determining unit further comprises a flag address determining sub-unit, being used to store the latest of the received data to the receiving-data temp region based on the second result and the flag address of the latest of the received data which is completely counted.

4. The data transmission system according to claim 1, wherein the receiving-data integrity determining unit further comprises a data comparison sub-unit, being used to compare whether the latest of the received data is the same with the previous received data based on the first result, to confirm whether the received data is completely transmitted.

5. The data transmission system according to claim 1, wherein the receiving-data integrity determining unit further comprises a data comparison sub-unit, being used to compare whether the latest of the received data is the same as the previous received data based on the first result and the counting of the of the flag address of the latest of the received data, and to confirm whether the received data is completely transmitted.

6. The data transmission system according to claim 2, wherein the receiving-data integrity determining unit further comprises a data comparison sub-unit, being used to compare whether the latest of the received data is the same as the previous received data based on the first result and the counting of the of the flag address of the latest of the received data, and to confirm whether the received data is completely transmitted.

7. The data transmission system according to claim 1, wherein the received data, the previous received data and the transmitted data are serial information.

8. A data transmitting method, applied for a data transmission system, comprising:
step S01, outputting a received data from a master terminal to a slave terminal, and inputting a transmitted data from the slave terminal to the master terminal;
step S02, determining whether the data transmission system receives an interrupt signal by an interrupt-signal detecting unit, and to generate either a first result or a second result, accordingly;
step S03, determining whether the received data is completely received by a receiving-data integrity determining unit, if not, then proceeding to step S04;
step S04, storing a flag address of the received data, a flag address of the transmitted data and the first result to a transmitting-data temp region;
step S05, determining whether the interrupt signal is finished by the interrupt-signal detecting unit, if yes, then proceeding to step S06; and
step S06, outputting at least one of the transmitted data, a flag address of the received data, a flag address of the transmitted data and the first result, to the master terminal from a transmitting region to the mater terminal.

9. The data transmitting method according to claim 8, wherein the step S03 further comprises:
step S07, determining whether a counting of the flag address of the latest of the received data is complete by a flag address determining sub-unit of the receiving-data integrity determining unit based on the first result, and to confirm whether the received data is completely transmitted, if no, then proceeding to step S04.

10. The data transmitting method according to claim 8, wherein the step S03 further comprises:
step S08, comparing whether the latest of the received data is the same with the previous received data by a data comparison sub-unit of the receiving-data integrity determining unit based on the first result, to confirm whether the received data is completely transmitted, if no, then proceeding to step S04.

11. The data transmitting method according to claim 8, wherein the step S03 further comprises:
step S07, determining whether a counting of the flag address of the latest of the received data is complete by a flag address determining sub-unit of the receiving-data integrity determining unit based on the first result; and
step S08, comparing whether the latest of the received data is the same as the previous received data by a data comparison sub-unit of the receiving-data integrity determining unit based on the first result, and thereby to confirm whether the received data is completely transmitted, if no, then proceeding to step S04.

12. The data transmitting method according to claim 8, wherein the received data, the previous received data, and the transmitted data are serial information.
